(19) United States
(12) Patent Application Publication
(10) Pub. No.: US 2004/0246964 A1
(43) Pub. Date: Dec. 9, 2004

(54) Method and device for header compression in packet-oriented networks

(76) Inventors: Jochen Grimminger, Munchen (DE); Hans-Peter Huth, Munchen (DE)

Correspondence Address: MORRISON & FOERSTER LLP, 1650 TYSONS BOULEVARD, SUITE 300, MCLEAN, VA, 22102, US

(21) Appl. No.: 10/491,082

(22) PCT Filed: Sep. 25, 2002
(86) PCT No.: PCT/DE02/03629

(30) Foreign Application Priority Data
Sep. 27, 2001 (DE) 101 47 755.4

(51) Int. Cl. H04L 12/56

(52) U.S. Cl. 370/392; 370/474

(57) ABSTRACT

The invention relates to a method for header compression in packet-oriented networks, comprising at least one receiver and one transmitter between which information packets are exchanged by means of MPLS headers. Said information packets are tunneled by another protocol by means of a network header. Said MPLS headers are selected, such that a clear representation of a MPLS header an the second network header is possible. Said method comprises a first initialization step, whereby the receiver stores a representation of said MPLS header on the network header. In a second step following said initialization step, the transmitter removes the network header of the second protocol from the information packet and fills in the free space, thus obtained, with other information, in order to then transmit said information packet to the receiver. Said method comprises a third step, whereby the receiver assigns the network header to the information packet, based on the stored representation.

### CLAIM FOR PRIORITY

This application claims priority to International Application No. PCT/DE02/03629, which was published in the German language on Apr. 10, 2003, which claims the benefit of priority to German Application No. 10147755.4, which was filed in the German language on Sep. 27, 2001, the contents of which are hereby incorporated by reference.

### TECHNICAL FIELD OF THE INVENTION

The present invention relates to a method and device for heard compression in packet oriented networks.

### BACKGROUND OF THE INVENTION

The introduction of packet-oriented technologies such as UMTS and GPRS has led to the expectation that in future there will increasingly be wireless transmission of packet data. In such cases packet data transmission will not only be restricted to the transmission of voice information, but other services, such as are offered in the Internet for example will be used wirelessly.

At present, most mobile radio networks are constructed on a connection-oriented basis. This connection orientation is present at least between the terminal and the base station. The backbone networks, on the other hand, often have a packet-oriented structure. For voice and data transmissions in particular, however, the entire bandwidth is not needed since packet data transmission only occurs at discrete points in time and often there is a long period between the individual actual information transmissions. This means that a large amount of the bandwidth is wasted. Packet-oriented networks have the advantage that only the bandwidth needed is used by packets. The data stream here is a broken down into small packets. The disadvantage of this approach, however, is that under some circumstances, if there is high demand, there is not sufficient bandwidth available. With voice transmission in particular this results in a significant loss of quality which is reflected in bad sound quality. A Quality Management for such networks is required. It's also necessary for the data packets to be routed more quickly through the network. To achieve this fast switches and routers are demanded.

In order to meet the increased volume of data for wireless subscribers in the future, access networks for mobile radio networks will in the future also be IP-based, i.e. between a base station and the gateway into the core network there will be an IP-based transport network known as the RAN (Radio Access Network). Terminals connect over an air interface, initially with a base station BS which terminates the air interface. Then the data of the terminal (mobile handset) MH is routed through an access router AR. As a rule the interconnected access routers form the Radio Access Network. The AR looks after the forwarding of information to the Radio Access Servers (RAS) or further routers.

As a result of the different topology of the network, a protocol tunnel is often set up between terminal MH and access router RAS or between AR and RAS. A protocol tunnel is always present if a first transmission protocol is encapsulated in a second transmission protocol. This is referred to as packing up the packets of a first transmission protocol into the packets of the second transmission protocol. This is always necessary, for example, if the first transmission protocol is not supported on a network segment. The packet must then be routed with the aid of the second transmission protocol in this network segment. A protocol tunnel provides a series of advantages.

For the terminal, RAN mobility can be supported transparently in the transport network with any given means. This advantage is based on the fact that the packets are not changed and thereby the type and form of transport can be determined by the topology of the network without the fear of the payload data being changed. Non-IP-based data (e.g. compressed or encrypted IP packets, voice) can be simply routed via the transport network RAN to appropriate converters on the edge of the transport network RAN provided the tunnel technology used supports the transport of data packets of protocols other than IP.

Known methods use tunnels either from the terminal MH to the RAS or from access routers AR to the RAS. In this case, different technologies can be used, for example PPP, IP-in-IP.

Because of the simple structure and the high performance, Multiprotocol Label Switching (MPLS, IETF Proposed Standard, [RFC 3031]) can also be used to advantage in tunnel technology.

With MPLS networks, a packet migrates from one router to the next. Each router makes an independent decision as regards forwarding. This means that each router analyses the header of the packet and each router runs a program with the router algorithm. Each router selects a new route depending on the results of the router algorithm. The next route is thus selected in two steps. The first step partitions the entire amount of the possible packets into a set of equivalent classes (FEC)., The second step maps each FEC onto a route. As regards the forwarding of the information, no distinction is made between the packets which belong to the same FEC. Different packets which belong to the same FEC cannot be distinguished. This is where the present invention differs from the prior art. To enable labels to be used as addresses, there must a unique assignment to an FEC. This means that an FEC only ever comprises one label. This label is assigned to only one destination address.

The packets regarded as different packets are those which have a different destination or source address. In order to use MPLS for the present invention, however, a path and thereby the equivalence class must be unique. This means that an equivalence class stands for a unique source and destination device or entity. In an MPLS network the assignment to an FEC is only made once, when the packet enters the network. The FEC to which a packet is assigned is encoded as a short value which is referred to as the label. When a packet is sent to the next route the label is sent with it. At subsequent routers no analysis of the further contents of the packet is undertaken. Only the label is checked. The label is used as an index for a table from which the next route and the next label can be taken. The old label is replaced by the new label and the packet is forwarded to the next route. In an MPLS network forwarding is only controlled by the labels. This has a number of advantages. The routers only have to have low-level capabilities. They must merely be capable of analyzing the labels and checking in a table which route is assigned to this label in order to replace the old label by a new label. Furthermore a higher throughput can be realized by these simple tasks. Further advantages can be found in [RFC 3031].

A number of fundamentals are defined below. A label is a short, locally-significant identifier or which has a fixed length to identify an FEC. The label is used to represent an FEC to which the packet is assigned. In the basic use of the FEC this is assigned on the basis of the destination addresses of the network layer. The original use of the FEC does not involve encoding of the network address. It is precisely at this point that the present invention makes a distinction. By uniquely assigning the label to a unique path a network address is encoded.

To ensure that the routers assign the packets to the same equivalence classes the routers must regularly exchange information from which it can be seen which packets will be assigned to a label. Furthermore it is important that the same labels are not used by different routers where this makes unique identification of the previous router impossible. It a should further be pointed out that upstreams and downstreams are handled differently. Thus these do not necessarily feature the same labels In the MPLS architecture the decision as to whether to bind a specific label to a specific equivalence class is taken by the router which is downstream in relation to this binding. The router which is downstream then informs the router which is upstream of this binding. This information can for example be transmitted as piggyback information on other packets.

In a further embodiment, MPLS supports a hierarchy in which the processing of the labeled packets is completely independent of the level of the hierarchy. A packet which does not feature a label can be regarded as a packet for which the stack is empty. The use of the stack becomes clear when tunneling packets is discussed. Such tunneling can be found in the document [RFC 3031]. Packets are tunneled when they are routed via a network path which lies between two routers, in which case this network path in its turn can comprise a series of routers. If, for example, an explicit path was specified which comprises the routers R1 to R4 and if a path lies between routers R1 and R2 which includes the routers R1.1, R1.2, R1.3, a further label is pushed on to the stack by the router R1. The routers R1.1, R1.2, R1.3 now operate on this new second element. As soon as the packet arrives at router R2 the topmost element is popped from the stack. It is problematic if no label is on stack. With the normal MPLS architecture of the network address (normally the IP address) is analyzed to determine an equivalent class.

MPLS offers two types of route selection. One type of route selection defines the route right at the start. The individual routers through which the information must pass are determined. This is known as explicit routing. With hop-by-hop routing at the routers are not explicitly determined so that each router can determine on the basis of its tables what the subsequent router should be. The present invention can be operated with both route selection options.

Previous approaches for using MPLS start from the use of MPLS inside the network, for example in a mobile radio network between access routers AR RAS.

If the terminal MH changes during operation from router ARx to router ARy, it must re-register at the access router (authentication). With this movement of the terminal to another base station or to another access router this tunnel is now relocated by means of signaling to the current anchor point. For this, however, in different variants of the realization, IPv6 (IP Version 6) must be supported in the access network. As produced by the mapping of such architectures to existing IP backbones, a form of MPLS is primarily supported within such architectures. IP networks are thus realized as overlay/VPN (Virtual Private Network) structures and their packets just switched quickly, which means less network load and overhead in router operation. However, when information is tunneled, an overhead arises as regards the size of the information packets. IPv6 headers cause more than 40 bytes of header overhead with a transport data size of 60 bytes on average (IPv6 incl. routing header), of which the payload data in its turn only occupies around 20 bytes (VoIP) [RFC 3031, RFC 2460]. Use of a shim header or MPLS header only induces 4 bytes in each case. A shim header, also called an MPLS header, includes further status and administration information, in addition to the label, which occupies around 20 bits. Basically unique identification of the point-to-point link with its characteristics, for example Quality of Service (QoS) as well as naturally those of the relevant bearer is necessary.

Known methods for reducing the overhead consist of a computing-intensive compression procedure [RFC 2507] (price-rohc-epic-00.txt [www.ietf.org/internet-drafts]), which the individual components or routers must support. These procedures must manage the dynamic state during the connection in which case a great deal of resources (memory, CPU) are used and thus limits are imposed on the components in performance terms. With a large number of terminals (several thousand mobile phones) which have to be operated by one component the result can be a system overload.

It should, however, be pointed out that the problems mentioned are not just restricted to networks operated with mobile terminals. Rather this problem occurs wherever different network topologies and architectures meet each other and tunneling of information packets is necessary. No restriction of the present invention to mobile radio networks is intended.

### SUMMARY OF THE INVENTION

The present invention provides a method which reduces the size of the headers.

In one embodiment of the invention, there is a method for header compression in packet-oriented networks, with the network including at least one receiver and one transmitter between which information packets are exchanged with the aid of MPLS headers. Here, the information packets tunnel a further protocol with a network header, in which case the MPLS is selected so that a unique mapping of an MPLS header to the second network header is possible. By this mapping it is possible to remove a header over a specific period of time. In a first Init step, the receiver stores a mapping of the MPLS header to the network header. This storage can be initiated by an analysis of the information packet or by an event as described below. After the receiver has stored the mapping, the transmitter removes the network header of the second protocol from the information packet and fills the free space thus obtained with other information in order to transmit the information packet to the receiver. This makes it possible to greatly reduce the number of packets to be sent.

In a third step, the receiver uniquely assigns the network header to the information packet on the basis of the stored mapping. In a further embodiment, the original MPLS header can be replaced by the header or also just by parts (check numbers may be retained for example) of the tunneled protocol.

To ensure synchronization of the transmitter and receiver, the receiver transfers a notification to the transmitter after the init step has been completed. From this point on, the transmitter can remove the header or also just parts of it (check numbers may be retained for example) of the original network protocol.

Should the receiver be in a position to independently analyze the transmitted packet and on the basis of this information make it possible to map the MPLS header onto the network header, the transmitter can decide independently when it intends to remove the original header or also just parts of it. The transmitter can make this decision after a specific period of time has elapsed or after a specific number of successfully transmitted network packets. It is, however, also conceivable for the transmitter to notify the receiver that it intends to remove the header or just parts of it from the information packet. The second protocol is preferably IP, with the headers either being IP Versions 4 or IP Versions 6. In the ideal case, when the network is set up so that all packets can be switched completely by MPLS, meaning that the end points are unique in each case, the option is produced for exchanging at the previously needed IP headers for correct handling, i.e. routing in the network using a logic without the information being lost between the point-to-point paths. After the packet has arrived at the receiver the latter replaces the MPLS header by a copying operation with the original IP header or also just parts of it. A further option for determining the mapping lies in at the transmitter transmitting the mapping of the IP header or also just parts of it on to the MPLS header to the receiver before the removal of the IP header by the transmitter. This communication involves control information which is either transmitted piggyback on data information or by a separate control information packet.

A further component of the present invention is a transmitter in a packet oriented network, with the network comprising at least one receiver and one transmitter between which information packets are exchanged with the aid of MPLS headers. The information packets sent by the transmitter tunnel a further protocol with a network header, in which case the MPLS headers are selected so that a unique mapping of an MPLS header to the second header is possible. The transmitter features a processing unit which, depending on an event or a state, removes the network header of the second protocol from the information packet and fills the free space thus obtained with other information in order to then send the information packet thus modified over the network interface to the receiver. The transmitter implements those steps which are assigned to it already described above in the method. The processing unit is preferably a processor or a high-performance chip as used in routers. The chip is called the switching fabric here. The events can be managed and created internally or they are transferred by an external device such as the receiver. Thus the events can be created by an interrupt for example. This interrupt can for example be initiated by a timer.

A further option is to provide a counter which prepares the number of sent and error-free information packets or the authorization of the receiver in order to trigger an event depending on a specific threshold value.

In another embodiment, the transmitter transfers the mapping of the MPLS header onto the network header by a message to the receiver. A corresponding protocol is used for this which allows communication between receiver and transmitter. The information is transmitted over an appropriate network interface.

The transmitter preferably has the functionality and the means to integrate itself into IP networks. For this to be done it is necessary for the transmitter to be able to detect network headers in the IP format, in which case these can preferably be IPv4 or Ipv6. When a switching fabric is used the transmitter preferably also has the functionality and means of a router. However, it can also be a terminal or a gateway.

In an alternative embodiment, the mapping of the MPLS header to a network header is implemented by a function. This preferably involves a bijective function for which there is also a simple and quick-to-calculate inverse function The MPLS header is calculated by a bijective function from the network header. The advantage of the function is that the mappings do not have to be held in a table. This makes it possible to save a large amount of memory space.

A further aspect of the present invention is a receiver featuring the opposite functionality to the transmitter as already described in the method above. The receiver features a storage area in which as a rule a number of mappings of MPLS headers to network headers of stored. A processing unit has access to this storage area and can as a rule determine the correct network header using a search algorithm or hash algorithm. In a further embodiment a function is used which calculates the corresponding header. In this case, it is naturally necessary for a corresponding inverse function to be present at the transmitter. A further aspect of the receiver is a processing unit which assigns the network headers of the second protocol to the information packet which features a corresponding MPLS header. This processing unit is preferably a processor or a switching fabric, as used in routers for example. However, specific chips can also be used which are specifically optimized for finding and removing or replacing headers.

In particular, when the packet has to be forwarded or submitted for further processing where only IP headers can be accepted, the receiver replaces the MPLS header in the information packet by the network header, by copying the network header into the area which was intended for the MPLS header in order to then forward the information packet modified in this way at via a network interface.

In a further embodiment, the receiver analyzes the information packets arriving with the aid of the processing unit to establish whether a network header was already removed, so that, if the network header has not been removed, it can then store the MPLS header in relation to the network header in the storage area. This approach means that is not necessary for the transmitter and the receiver to exchange information about the beginning and end of the optimized communication. Thus, for example, a specific status bit or in other pattern could be used to notify the receiver that the transmitter has removed the header.

The processing unit can also be designed such that information packets arriving are analyzed in order to establish whether a network header has already been removed, so that, if a network header has not been removed, the MPLS header can be stored in relation to the network header in the storage area.

As already described for the transmitter, the header can be exchanged depending on an event or a state. Possible events of the expiry of a preferably synchronized timer, a specific number of received and error-free information packets or a corresponding notification of the transmitter. The mapping can also be determined by the transmitter which then transfers it to the receiver by an appropriate notification in the form of an information packet.

The receiver also supports IP, preferably in versions 4 and 6.

So that the mapping is unique, a unique identification of the point-to-point link or path with its characteristics (e.g. QoS) as well as naturally those of the relevant bearer is necessary where a mobile radio network is involved. Bearers are services in the mobile radio area which represent connections at different levels. To transport further additional information which cannot be covered by the MPLS headers under some circumstances, a further MPLS header is written into the stack of the information packet comprising further information. As already described above, stacking can be used for this. However, two or more MPLS headers are more than sufficient for this, with only one MPLS header having to have connection significance. The other MPLS header can even be used dynamically network-wide and one is not restricted to MPLS (e.g. PPP).

The other headers are used for identification of the point-to-point link and its characteristics, as requested in the IPv6 header. These can if necessary be modified by the network as long as the link scope for the end components is not destroyed. The internal headers are used to identify the bearer. The basic idea is that internally the MPLS headers are now uniquely defined again to an IPv6 header or can be replaced by this, which means that the architecture or features and advantages resulting from IPv6 are fully retained. The IP header can thus easily be removed.

To notify the IPv6 to MPLS header mapping and vice-versa to the relevant link end point, standardized protocols (e.g. LDP, [RFC 3036]) can now be used or a point-to-point simplification can be employed. Corresponding simplifications have already been described above. An important variant is the removal of only parts of the IP header. Security headers can, for example, easily remain unscanned and therefore security relationships are not destroyed. How the packets are handled in each case can either be determined by a uniqueness and analysis in the network or signaled by simple messages. By contrast with header compression as is known from the prior art, the present invention only needs a short table lookup if the information is stored in a two column table in the storage area.

In a further embodiment, the complete header is not removed but only elements of it. Thus, for example, only the address area which is later used again can be removed. The address area not only includes the address of the receiver but also the address of the transmitter or the route to it.

### BRIEF DESCRIPTION OF THE DRAWINGS

Exemplary embodiments are described below with reference to the Figures. The drawings show:

FIG. 1 shows a network linked to the Internet by a gateway.

FIG. 2 shows a section from FIG. 1 in which the method in accordance with the invention is used

### DETAILED DESCRIPTION OF THE INVENTION

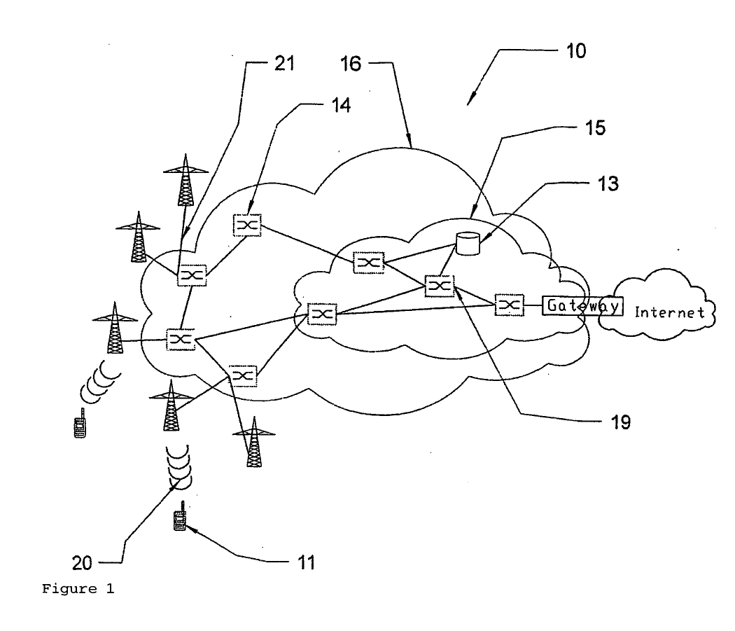

FIG. 1 shows a basic structure of a network in a radio area. A network architecture 10 here includes a Radio Access Network 16 and a Core Network 15. The Core Network 15 establishes the connection to the Internet via a gateway. Both networks consist of a series of components 19, 13, 12, 14. A User Plane Server (UPS) 14 administers the radio protocol 20 in order to transport information packets over the radio interface to terminal 11. A Radio Control Server (RCS) administers the frequency band and allows the distribution or rejects the distribution of frequencies if a bottleneck is likely to occur. These two components which also feature router functionalities, together with the corresponding cable connections, form the Radio Access Network 16.

The Core Network in its turn comprises routers 19, which are connected to the UPS. An HLR (Home Location Register) 13 administers the unique identification of the terminal and its current position. This position is, however, merely a region specification. Furthermore, the HLR/HSS administers the directory numbers and the current IP address.

The components of the Core Network and the Radio Access Network are connected to each other via glass fiber cables or copper cables 21. It is, however, conceivable for these components to be in contact with each other via a radio relay connection.

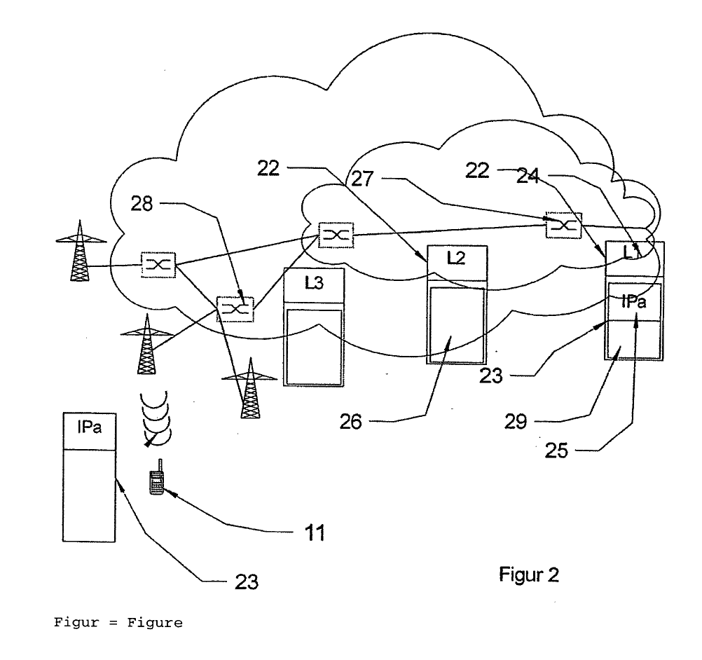

FIG. 2 shows a basic execution sequence for the method in accordance with the invention. A transmitter 27 receives an information packet 22 which features an MPLS header 24. This information packet 22 tunnels a further information packet 23 which features an IP header 25. The data area thus produced 29 is correspondingly small. The transmitter 27 now removes the IP header 25 and adds further information to it so that the data area 29 becomes larger. The packet modified in this way is forwarded via a further router which modifies the MPLS header according to the standard, to receiver 28. The receiver 28 now removes the MPLS header 24 and replaces this by an IP header. The mapping of the MPLS header to the IP header is stored by the receiver in a corresponding table or it creates it by a simple bijective function. The method for exchanging the mapping has already been described above. It has already been described at which point in time the removal of the IP header by the transmitter can take place. Because of the varying data area 29 it can occur that a number of packets are combined or split up. The prior art has an appropriate numbering system for these packets.

1. A method for header compression in packet-oriented networks, the network including at least one receiver and one transmitter between which information packets are exchanged with of MPLS headers, with the information packets tunneling a further protocol with a network header, with the MPLS header being calculated by bijective function from the network headers,
which is configured to map an MPLS header uniquely to the second network header, comprising:
storing a mapping of the MPLS header to the network header, with a network header being calculated by a bijective function from the MPLS headers,
removing from the information packet at least a portion of the network header of the second protocol and filling free space thus obtained with other information, and sending the information packet to the receiver: and
uniquely assigning the network header to the information packet based on the basis of the stored mapping.

2. The method in accordance with, claim 1, wherein the receiver sends a message the transmitter to notify it of completion of the storing.

3. The method in accordance with claim 1, wherein the transmitter, after a period of time has elapsed, removes the network header of the second protocol.

4. The method in accordance with claim 1, wherein the transmitter notifies the receiver that it is removing the network header of the second protocol for future information packets.

5. The method in accordance with claim 1, wherein the second protocol is IP, with the headers being IP versions 4 or IP versions 6.

6. The method in accordance with claim 1, wherein the receiver replaces the MPLS header with the original IP header in a copying operation.

7. The method in accordance with claim 6, wherein the mapping of the IP header to the MPLS header is transmitted, before removal of the IP header, by the transmitter to the receiver.

8. The method in accordance with claim 1, wherein a number of MPLS headers which are on the stack are used to map the network header.

9. The method in accordance with claim 1, wherein at least a part of the network header is replaced by MPLS headers.

10. A transmitter in a packet-oriented network, with the network comprising:
at least one receiver and one transmitter between which information packets are exchanged with she aid of MPLS headers, the information packets tunneling a further protocol with a network header, with the MPLS header being selected so that unique mapping of an MPLS header to the second header is possible, wherein
the MPLS header is calculated by a bijective function from the network header and the transmitter features a processing unit which, depending on an event or a state, removes the network header of the second protocol from the information packet and fills the space thus obtained with other information to send the information packet thus modified over a network interface to the receiver.

11. The transmitter in accordance with claim 10, wherein the event is expiry of a timer, a specific number of sent and error-free information packets and/or an authorization by the receiver.

12. The transmitter in accordance with claim 10, wherein the mapping of the MPLS header to the network header is transmitted by a message to the receiver.

13. The transmitter in accordance with claim 10, wherein the network header stands for an IP header.

14. The transmitter in accordance with claim 10, further comprising a unit to implement the functionality of a router.

15. The transmitter in accordance with claim 10, wherein at least part of the network header is replaced by MPLS headers.

16. A receiver in a packet oriented network, comprising:
at least one receiver and one transmitter, between which information packets are exchanged with aid of MPLS headers, where the information packets tunnel a further protocol with a network header, the MPLS headers being selected so that a unique mapping of an MPLS header to the second network header is possible;
a storage area in which a mapping of the MPLS header to the network header is stored, in which case the network header is calculated by a bijective function from the MPLS header; and
a processing unit which assigns the network header of the second protocol to the information packet which features a corresponding MPLS header.

17. The receiver in accordance with claim 16, wherein the MPLS header in the information packet is replaced by the network header, the network header being copied into an area which was intended for the MPLS header for it to forward the information packet modified over a network interface.

18. The receiver in accordance with claim 16, wherein the processing unit analyzes information packets that arrive in order to determine whether a network header has already been removed, and if the network has not been removed, stores the MPLS header in relation to the network header in the storage area.

19. The receiver in accordance with claim 16, wherein the processing unit analyzes information packets that arrive in order to determine whether a network header has already been removed, and if a network header has been removed, stores the MPLS header in relation to the network header in the storage area.

20. The receiver in accordance with claim 16, wherein analysis of the information packets is undertaken on the basis of bit patterns.

21. The receiver in accordance with claim 16, wherein the mapping of the MPLS header to the network header his undertaken depending on an event or a state, where the event is the expiry of a synchronized timer, a specific number of received and error-free information packets or a corresponding notification of the transmitter.

22. The receiver in accordance with claim 16, wherein the storage of the mapping of the MPLS header to the network header is transmitted by a message to the transmitter.

23. The receiver in accordance with claim 16, wherein the network header is an IP header.

24. The receiver in accordance with claim 16, further comprising a unit to implement the functionality of a router.

25. The receiver in accordance with claim 16, wherein at least part of the network header is replaced by MPLS headers.
